(19) United States
(12) Patent Application Publication
(10) Pub. No.: US 2004/0022222 A1
(43) Pub. Date: Feb. 5, 2004

(54) Wireless metropolitan area network system and method

(76) Inventor: Allister Clisham, La Jolla, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/211,173

(22) Filed: Jul. 31, 2002

(51) Int. Cl. H04Q 7/24

(52) U.S. Cl. 370/338; 370/469

(57) ABSTRACT

A system and method are disclosed for providing a high speed wireless network. In one embodiment, a network is configured in a star configuration having a single router at the center. A Metropolitan Access Network (MAN) is configured with a plurality of access points that provide a wireless interface using defined physical layer and Media Access Control (MAC) layer. Packet data delivered to and from the access points are connected to the single router using a plurality of layer two links, which may include point to point links and packet switches. All links within the network operate at layer two or below and do not modify the packet data. The single router at the center of the MAN star network uses layer three information to direct packets between Local Area Networks (LANs) or sub-networks connected to different ports on the router.

### BACKGROUND OF THE INVENTION

1. Field of the Invention

The invention relates to the field of electronic networks including high speed wireless metropolitan area networks.

2. Description of the Related Art

Numerous types of communication networks have become integral parts of modern day life. Networks may, for example, be implemented as packet switched networks or circuit switched networks. The most common networks include wireline telephone networks, wireless telephone networks that are typically connected to the wireline telephone networks, cable television networks, and Local Area Networks (LANs) that are typically used to connect a number of microcomputers.

The Open Systems Interconnection (OSI) model provides a somewhat formalized model of an implicit layered architecture that is inherent in many network architectures. However, not all networks may have layers that exactly correspond with the layers described by the OSI model.

The OSI model describes network functionality in terms of seven layers. The lowest or most basic layer is Layer 1, also referred to as the physical layer. The physical layer consists of a transmitter, receiver, and channel over which signals are propagated. The transmitter takes a signal and modulates it using an information signal from a higher layer to create an electromagnetic wave that is propagated over the channel to the receiver where the modulating signal is recovered. The channel may, for example, be a wireless link, wireline link, or optical link.

Above the physical layer is a data link layer that is known as Layer 2. The data link layer supervises the transmission of data over the physical layer. For example the data link layer at the transmitter may add error detection bits to the data that is to be sent along the physical layer. The data link layer in the receiver may use the error detection bits to determine whether or not to request retransmission over the link. Some links may not implement retransmission and error detection along each link, but may instead implement end-to-end error detection and retransmission, which is handled in another layer.

Layer 2 may be divided into two sub-layers for networks that are implemented over common links, or common channels. These links are typically referred to as multiple access links. A first sub-layer is the Media Access Control (MAC) layer. The MAC layer uses protocols to regulate access to a common link. As an example, the MAC layer may append data with a physical address of the destination to identify the destination on a shared link. The MAC standard may define packet formats, addressing schemes, and MAC protocols.

A second sub-layer is the Logical Link Control (LLC) layer. The LLC performs the same functions that the data link layer performs by itself in a point-to-point link. These functions include error detection and retransmission determinations.

Layer 3 is defined as the network layer. The network layer performs the routing of data packets along and among the various links in a network. Network standards may specify packet formats, addressing schemes, and routing protocols.

Layer 4 is defined as the transport layer. The transport layer is used to decompose messages into packets at the transmitter and to combine and resequence received packets into received messages. Layer 4 also performs flow control and end-to-end error control.

Layer 5 is the session layer, which is used to supervise the connection between source and destination. Layer 6 is the presentation layer, which is used to convert a syntax that is used in a particular communication device to one that is common to a network. The highest layer is layer 7, which is the application layer. The application layer is the layer on which user applications are run.

Presently available networks, such as wireline telephone networks, wireless telephone networks, and the Internet have data bandwidths that are limited by bottlenecks in the network structure. Networks such as wireline telephone networks are inherently bandwidth limited because of the nature of the signals that they were originally designed to carry. Other networks, such as wireless telephone networks are bandwidth limited because they must interface with legacy systems that are bandwidth limited and because they operate in environments where portions of the physical layer, for example the available Radio Frequency (RF) bandwidth, are limited. Still other networks, such as the Internet, are not inherently bandwidth limited, but may be operationally bandwidth limited because of the structure of the network and the limited number of resources that must be shared.

Bandwidth limited networks cannot provide the high data rates required for two-way high speed data communications or for applications such as video conferencing, real time streaming video, video broadcast, or video on demand. Although some of the above-identified networks may be capable of providing some form of high speed data transmission, they may only be able to provide these functions at an extreme cost, or may only be able to provide limited function. As an example, streaming video transmitted over the Internet for an application such as a video conference may achieve a marginally acceptable quality of service only where an inordinate amount of bandwidth, such as a T-1 line, is dedicated to the application. Video conferencing over non-dedicated Internet connections are of such marginal quality that they are virtually unusable. Point-to-point video conference connections are possible, but only at a high cost. Such point-to-point links also have dedicated source and destination and are not conducive to interfacing with mobile devices.

### SUMMARY OF THE INVENTION

A communications system is disclosed which provides broad band wireless communications. A network has a router in the center of a star configuration. One or more network branches connect ports on the router to switches, access points, or other communication devices. Access points are either directly or indirectly connected to the router. The access points provide wireless communications links from the network to user devices. The wireless access points use a first layer two protocol for the wireless communication link. A second layer two protocol is used from the wireless access point to the router.

Data packets received by the access points over the wireless link are directed to the router. The router determines routing decisions based in part on the layer three information contained in the data packet.

### BRIEF DESCRIPTION OF THE DRAWINGS

The features, objects, and advantages of the invention will become more apparent from the detailed description set forth below when taken in conjunction with the drawings in which like reference characters identify correspondingly throughout and wherein:

FIG. 1 is a functional block diagram of a Metropolitan Area Network (MAN).

FIG. 2 is a functional block diagram showing a data path from a content server to a destination.

FIG. 3 is a functional block diagram showing a data path from a content server to a destination and also showing the billing server.

FIG. 4 is a functional block diagram showing a video conferencing connection between two devices and also showing the billing server.

FIG. 5 is a functional block diagram showing transitions through the layered communication protocols.

### DETAILED DESCRIPTION OF EMBODIMENTS OF THE INVENTION

Systems and methods are described for a high speed network capable of supporting data intensive tasks such as video on demand and video conferencing. The following embodiments disclose a wireless network interfacing with user devices over a plurality of access points such as those operating in accordance with Institute of Electrical and Electronics Engineers (IEEE) standard 802.11. The user device may be a telephone, personal digital assistant (PDA), notebook computer, teleconferencing device, or any other device capable of communicating over the network. Additionally, the interface to the network is shown to be a wireless interface, but the interface may be wireless, wireline, fiber, optical, or any other interface capable of supporting network communication requirements.

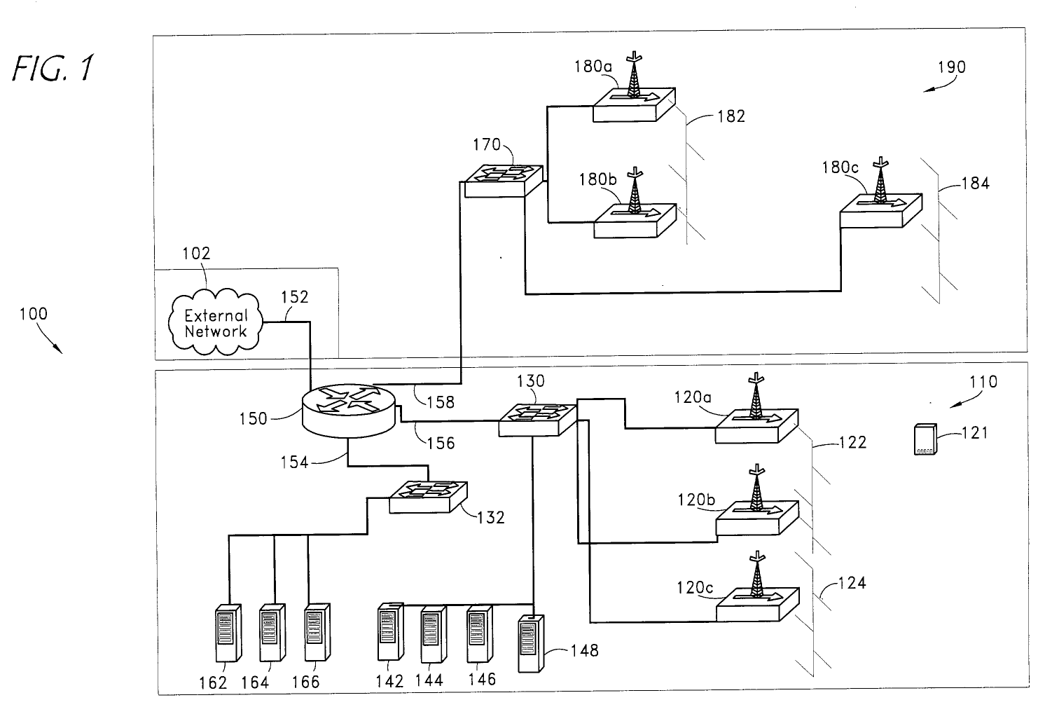

FIG. 1 is a functional block diagram of a metropolitan area network (MAN) 100 configured to enable communication that can support video on demand and video conferencing. The MAN 100 includes a first sub-network 110 and a second subnetwork 190 connected to a single router 150. The sub-networks, 110 and 190, are connected to the router 150 in a star configuration such that only a single router 150 is used. A star configuration, or star topology as it may alternatively be called, uses a set of point to point links that radiate from a central location. The router 150 is the central location in the MAN 100 star configuration. Although only two sub-networks, 110 and 190, are shown in FIG. 1, any number of sub-networks may be connected to the router 150.

The following network 100 is described using references to OSI layers. However, communication over the network 100 is not limited to communication protocols aligning with OSI layers. More generally, the systems and methods apply to networks implementing layered communication protocols.

For example, each of the communication links in the network 100 comprises a physical channel. Communication over the physical channel uses a first communication protocol or layer. The first communication protocol may in turn encode or encapsulate a second communication protocol that contains address information relating to the source and destination devices in each of the communication links within the network 100. The second communication protocol may in turn encode or encapsulate a third communication protocol that contains address information used by the network to identify particular devices. Further higher level protocols can similarly be used.

For example, the first communication protocol may be a physical layer protocol for communicating information over a wireline link. Information bits may be represented in the first communication protocol as voltages on the wireline link. Thus the first communication protocol encodes the second communication protocol by transforming the information bits in the second communication protocol into voltages for transmission along the wireline link.

Similarly, the second communication protocol may be a point to point protocol. The second communication protocol may encode or encapsulate the third communication protocol by appending bits to the information encoded with the third communication protocol. For example, the appended information may include a preamble, second communication protocol source and destination addresses, and error detection bits or other second communication protocol fields.

A level of communication protocol is typically transparent to any other level of communication protocol. For example, the information that the second communication protocol appends to the third communication protocol is transparent to the third communication protocol. The operation of the third communication protocol does not rely on a particular implementation of the second communication protocol. Similarly, the second communication protocol does not assume or require any particular configuration of the third communication protocol. A data packet encoded according to the third communication protocol is treated as a data packet by the second communication protocol.

Thus, protocol specific information and encoding may be performed by each communication protocol. Each communication protocol treats information encoded using another communication protocol as data. As an example, the third communication protocol encodes a data packet. The data packet may have previously been encoded by another communication protocol. The second communication protocol treats the entire encoded packet from the third communication protocol as data. Thus, to encode or encapsulate the data packet, the second communication protocol may transform the third communication protocol data packet. The second communication protocol may append header or trailer bits to the data packet, may compress or other wise process the data packet, and may segment the data packet into multiple data packets. The second communication protocol may include a number of fields specific to the second communication protocol. Where the third communication protocol encoded packet is segmented into smaller data packets, the second communication protocol may treat each segmented data packet as an individual non-segmented data packet. Thus, the second communication protocol typically does not distinguish between underlying data bits and data bits appended by the third communication protocol.

Similarly, when second communication protocol data packets are received, the second communication protocol may be removed leaving higher communication protocol data packets. The third communication protocol may also be removed to extract higher level data packets.

A first device having a third communication protocol address may communicate with a second device having a different third communication protocol address. The first device may use the third communication protocol to encode information as a data packet. For example, the third communication protocol address of the first device may be used in a source field in the third communication protocol. The packet may then be encoded using the second communication protocol. There may be distinct second communication protocol addresses used in fields of the second communication protocol. The second communication protocol encoded packet may be further encoded with the first communication protocol before being sent along a physical channel.

The MAN 100 shown in FIG. 1 includes a router 150 having a plurality of ports. The router 150 performs routing and packet forwarding functions using the network layer, or layer three, information embedded in data packets transmitted to a port on the router 150. The router 150 stores routing tables that allow it to determine to which port data packets are to be routed. For example, the router 150 may be a CISCO 12000 series router, from Cisco Systems, Inc.

Alternatively, a controller, such as a Media Access Control (MAC) layer controller, may be connected to the router 150. The controller may store the MAC layer addresses of various devices within the network and associate ports on the router 150 with addresses. The router 150 operates in conjunction with the controller to determine the correct port to which packets are to be routed.

For example, a user device 121 may be associated with a first access point 120a. The user device 121 may request content from an IP address corresponding to a video server, e.g. 162. The MAC controller may store information that indicates the communication path from the user device 121 to the router 150. The user device 121 communicates to the first access point 120a. The first access point 120a communicates with the second switch 130 and the second switch communicates with the router 150. Additionally, the MAC controller may store information that indicates the communication path from the router 150 to the video server 162. The router 150 communicates with a first switch 132, which communicates with the video server 162.

Each port on the router 150 is coupled to a device by a network branch. Three of the ports are coupled by network branches, 154, 156, and 158 to switches 132, 130, and 170 respectively. A fourth port is connected to an external network 102. The external network 102 may be a meshed network having a plurality of routers, and may be another subnetwork, or the external network 102 may be a Wide Area Network (WAN), such as the Internet. The MAN 100 may be configured such that the network branch 152 coupling the port on the router 150 to the external network is intentionally bandwidth limited. The network branch 152 operates as a bottleneck for data passing from and to the network 100. For example, the network branch 152 connecting the router 150 to the external network 102 may be a 10Base TX or 100Base TX communications link, or some other link having only limited data rate capabilities. A switch, such as the first switch 132, is a multi-port device that selectively forwards packets from one of its ports to another. The switch's forwarding decision is based on layer two information. The switch 132 does not modify a received packet. For example, the switch 132 may be a CISCO 3500 series switch from Cisco Systems, Inc., such as a 3508 Ethernet switch.

One or more devices are connected to one or more of the other ports on the first switch 132. Three servers, 162, 164, and 166, are shown coupled to a port on the first switch 132 that is different from the switch port that is connected to the router 150. For example, each of the servers 162, 164, and 166 may store video content. The servers 162, 164, and 166 may also control the broadcast of the video content to user devices connected to the network 100. The video content may be broadcast as digitized video and may be broadcast as compressed video. The server software may support one or more forms of video compression, such as Motion Picture Experts Group (MPEG) video compression, such as MPEG2 or MPEG4. A high quality video stream encoded using MPEG2 uses approximately six Mbits per second of data bandwidth. In one embodiment, the connection from the server 166 to the first switch 132 is a 100Base FX fiber connection capable of supporting 1000 Mbit/s. The server is then limited to providing 166 video streams encoded using MPEG2 video compression. The number of video streams supported by a particular server 162, 164, or 166, may be limited by constraints other than the bandwidth of the connection from the server, e.g. 166, to the first switch 132. The amount of processing power in the servers 162, 164, and 166 or limitations on the speed or amount of content storage may also affect the number of video streams supported by a single server 162, 164, or 166. For example, each of the servers 162, 164, and 166 may be an Apple Xserve™ computer running streaming server software such as Quicktime™. Each server may then be able to support sixty video streams. The second switch 130 has a first port connected to a port on the router 150. A second port on the second switch 130 is connected to a plurality of servers. The plurality of servers includes an IP/TV control server 142, an IP/TV content server 144, an IP/TV broadcast server 146, and a Dynamic Host Configuration Protocol (DHCP)/Domain Name System (DNS) server 148. A third port on the second switch 130 is connected to a number of access points 120a-120c. A link is used to connect each access point 120a-120c to the port on the second switch 130. The access points 120a-120c provide wireless interfaces from the network 100 to user devices, for example a user device 121 near the first access point 120a. The user devices do not form a part of the network 100, but are able to connect to and communicate over the network 100 using, for example, a wireless link to an access point 120a-120c.

Servers that perform administration, such as the IP/TV control server 142, or the DHCP/DNS server 148 typically do not require high data rate connections to the network. Thus, the connection from the servers 142 and 148 may be lower rate connections such as a 100Base TX link.

The IP/TV servers 142, 144, and 146 may be configured to broadcast multicast video streams to user devices connected to the network 100. In order to provide a multicast broadcast to all users connected to the network 100, the broadcast video needs to be streamed to each of the wireless access point, for example 120a. Streaming broadcast video to all of the users may not be a desirable use of the system resources. Thus, the IP/TV servers 142, 144, and 146 may connect to the remainder of the network 100 through the second switch 130. The second switch 130 can then act to limit the effects of a multicast video stream on the network 100. That is, the second switch 130 may act to limit the multicasting capabilities of the IP/TV servers 142, 144, and 146 in order to preserve system resources for other applications.

The third switch 170 operates in a second sub-network 190. A first port on the third switch 170 is connected to a port on the router 150. A second port on the third switch 170 is connected to three access points 180a-180c within the second sub-network 190. A link connects each of the access points 180a-180c to the port on the third switch 170. The three access points 180a-180c connected to the third switch 170 provide wireless access to the second sub-network 190 of the network 100.

The MAN 100 may be configured to support any type of data protocol. For example, the MAN 100 may be an Ethernet network operating in accordance with IEEE 802.3. In alternative embodiments, the MAN 100 may communicate using Asynchronous Transfer Mode (ATM), or some other communications protocol.

The MAN configuration with the router 150 in the center results in all routing, which would be classified as OSI layer three and above, occurring within the router 150. This can be advantageous because the router 150 may be the only device within the network 100, aside from the source and destination, which is required to examine layer three or above information in the data packets. The use of a single router 150 allows all of the switches, 130, 132, and 170, within the network 100 to operate using layer two, MAC layer, or lower layer information to direct data packets.

For example, each of the access points, 120a-120c and 180a-180c, is configured to receive data packets from a source connected to the MAN 100. The access points forward or direct the packets across the wireless links to the appropriate user devices based upon layer two information. The user devices receive each of the transmissions, examine the layer two address, and discard the packets for which they are not the destination. Similarly, the access points, 120a-120c and 180a-180c, receive data packets and forward or direct the data packets to all network branches to which they are connected (with the exception of the source or initiating branch). The individual access points, for example 120a, may be the destination for some data packets. The access point 120a does not forward data packets for which it is the destination.

Other than the router 150, the switches, 130, 132, and 170, may be the only devices that make any data forwarding, or data directing, decisions. However, the switches, 130, 132, and 170, make their forwarding decisions based on layer two or MAC layer information. The switches, 130, 132, and 170, do not use layer three or above information. For example, a switch 130 does not use TCP or IP information to direct data packets. Thus, a data packet from an access point may be directed across a communication path to the router. The communication path may include one or more point to point links. The data packet is directed across the point to point links using layer two information.

The switches 130, 132, and 170 selectively forward packets based on layer two information. A switch builds a table relating a port number on the switch to a MAC address of each device to which it is connected. The switch may build the table by associating the MAC address of incoming data packets with the number of the switch port through which the incoming data packet is received. The switch, 130, 132, or 170 may simultaneously forward packets to a plurality of ports if the switch cannot resolve to which switch port the packet should be directed. Additionally, the switch may forward data packets to a plurality of ports if the packets are directed to more than one port. The switches 130, 132, and 170 may forward a packet after it has been fully received or may forward packets as soon as the correct output port has been determined. The first sub-network 110 may be configured in a first geographic location and may be located in a geographic location that is mutually exclusive and remote from the second sub-network 190. As an example, a first subnetwork 110 may be in San Diego along with the single MAN router 150, and a second subnetwork 190 may be in New York. A network branch couples the second sub-network 190 in New York to the router 150 in San Diego. In this example, no other routers are implemented within the MAN between the second sub-network 190 and the router 190 in San Diego. Alternatively, the first sub-network 110 may be placed at a location that is relatively close to, and in some cases may overlap, the location of the second sub-network 190.

Any of the network branches, 152, 154, 156, and 158 may be implemented using wireline links or wireless links having sufficient bandwidth. The network branches 154, 156, and 158 connecting ports on the router 150 to switches 132, 130, and 170 respectively, may be 100Base FX multimode fiber links. The network branches 154, 156, and 158 may, for example, be free space optical links. Similarly, any of the links from the switches 130, 132, and 170 may be implemented using wireline links or wireless links of sufficient bandwidth. Examples of links include, but are not limited to, wired links, radio frequency links, and optical links, including fiber and free space optical links.

The first sub-network 110 shows three of the connection points configured as access points 120a-120c adapted to operate as wireless connection points to the network 100. For example, the access points, 120a-120c, may operate in accordance with IEEE 802.11. The IEEE 802.11 standard specifies a physical layer (PHY) and Media Access Control (MAC) layer for wireless communication of data. A comparison to the OSI model shows that the physical layer and MAC layer defined by the IEEE 802.11 standard are layer 1 and layer 2, respectively. Thus, a user device, for example user device 121, interfacing to the network 100 at an access point uses communication protocols that are no higher than layer 2 to access the network. Of course, the actual data carried over the layer 2 link may include higher layer information, but the higher level information is not extracted nor needed for the link between the access points 120a-120c and a user device. Although only three access points 120a-120c are shown in the first sub-network 110, any number of access points may be integrated into the network 100. Furthermore, the access points 120a-120c may be configured to operate according to IEEE 802.11a or IEEE 802.11b, or some other wireless interface standard, and within each particular standard, the access points 120a-120c may be configured to operate in any of the frequency bands defined within the specifications. For example, an access point 120a-120c may be configured to operate in one or more of the frequency bands specified for the three regions defined in IEEE 802.11. Alternatively, proprietary protocols may be used and the wireless links may operate in one or more frequency bands in combination with, or exclusive of, wireless links that operate using one or more optical wavelengths.

Each of the access points, 120a-120c, provides a corresponding wireless coverage area. The coverage areas of any two or more access points, 120a-120c, may overlap. Alternatively, the coverage areas of any two or more access points, 120a-120c, may be mutually exclusive.

The access points can communicate with user devices using radio frequency (RF) links, such as those implementing frequency hopping or direct sequence spread spectrum, or the access points may communicate with the user devices using optical links, which can be implemented as infrared links. The access points 120a-120c can be configured to communicate with user devices using direct sequence spread spectrum or an Orthogonal Frequency Division Multiplexing (OFDM) system to provide a wireless LAN with data payload communication capabilities of 6, 9, 12, 18, 24, 36, 48, 54 Mbit/s, or some other data rate that is capable of supporting the desired service, such as video signals. The radio frequency (RF) signals may be modulated using binary phase shift keying (BPSK), quadrature phase shift keying (QPSK), 16-quadrature amplitude modulation (QAM), 64-QAM, or another form of modulation. The RF center frequency may be centered in any frequency band that is capable of supporting the desired applications. The RF operating frequencies of the transmit and receive signals from the access points may be the same frequency or may be at different frequencies. For example, the RF center frequencies may be substantially in the bands 2.4-2.5 GHz, 2.471-2.497 GHz, 2.445-2.475 GHz, 2.4465-2.4835 GHz, 2.4-2.4835 GHz, 5.15-5.25 GHz, 5.25-5.35 GHz, 5.725-5.825 GHz, or any other suitable band of RF frequencies.

A single Medium Access Control (MAC) layer may support multiple physical layer implementations. Thus, regardless of the operating frequency band of the wireless links or the type of modulation used in the wireless links, the MAC may remain the same. The MAC layer may integrate carrier sense multiple access with collision detection or collision avoidance. When a node or device has data to transmit, the node first listens to see if a carrier, or signal, is being transmitted by another node. The device, for example, may monitor whether signals are being carried in the transmit or receive frequency bands. The individual bits may be sent by encoding them with a clock using Manchester encoding. Data may be sent when no carrier is detected and the physical medium is idle. Any other device connected to the access point, 120a-120c, which does not need to transmit, listens to see if other devices have started to transmit information to it or to see if the physical medium is being used to by other devices.

However, carrier sense alone is unable to prevent two devices from transmitting at the same time. If two devices simultaneously attempt to transmit, both could see an idle physical medium, for example due to propagation delays along the network between devices. The devices may erroneously conclude that no other device is currently using the network. If more than one device simultaneously attempts to transmit, a collision may occur. The collision will result in the corruption of the data being sent. A receiving device typically discards corrupted data. The receiving device may detect a corrupted frame by verifying a cyclic redundancy code (CRC) at the end of the frame of data.

In collision detection, each transmitting device monitors its own transmission, and stops transmission immediately if it observes a collision. The device may then transmit a jam sequence. The jam sequence ensures that other devices, which may currently be receiving the transmitted frame, will receive the jam signal in place of a correct CRC. The incorrect CRC ensures the other receivers will discard the frame due to a CRC error. When two or more transmitters each detect a collision, each responds by transmitting the jam sequence. Each device may then attempt to retransmit data following a random delay. A maximum limit may be defied for the number of frame retransmissions.

Collision avoidance may be preferred over collision detection because of the nature of a RF wireless link, or because of the length of roundtrip delays across the network. In collision avoidance, each device listens for any traffic over the channel. A device may transmit a signal during an idle period to indicate that it will be using the network. A device may use a request to send/clear to send (RTS/CTS) protocol in order to avoid collisions. Because not every device may be able to detect the transmissions of every other device in a wireless link, a device may back off from transmitting if it hears any portion of the RTS/CTS exchange of another device. A receiver may transmit an acknowledgement following receipt of a valid frame.

In another embodiment, an access point may successively poll devices to determine whether they have any data to transmit. The polling technique limits the number of collisions and eliminates problems of a device not being able to hear the transmission of another device.

In any of the above techniques, a minimum frame size may be specified for data. The minimum frame size may be related to the distance over which the network spans, the type of physical channel being used, and the number of repeaters that the signal may have to pass through to reach the furthest part of the network.

Because the data from and to the access points, 120a-120c, are wireless transmitted, some form of data encryption may be incorporated to provide a level of privacy or confidentiality. Data to be wireless transmitted may be encrypted using a pseudo random noise sequence. The original data may be recovered from the encrypted data using the same pseudo random noise sequence. For example, a form of encryption known as Wireless Equivalent Privacy (WEP) may be implemented to increase the confidentiality of data transmitted across a wireless link.

Returning to FIG. 1, a user device 121 may connect to the network 100 by associating with an access point, 120a-120c. An access point, for example 120a, may be a wireless transceiver such as a radio frequency transceiver or an optical transceiver. For example, a user device 121 may initially associate itself with a first access point 120a. The coverage area of the first access point 120a may overlap a coverage area of a second access point 120b. The user device 121 may move anywhere within the coverage area supported by the first access point 120a and remain in communication with the first access point 120a. Although the user device 121 may move into and out of the portion of the coverage area of the first access point 120a that overlaps with the coverage area of the second access point 120b, the device remains associated with the first access point 120a.

The user device 121 may no longer be able to successfully communicate with the first access point 120a once the user device 121 roams outside the coverage area supported by the first access point 120a. However, the user device 121 may move into a coverage area supported by another access point, such as the second access point 120b. The user device 121 scans for another access point, 120a-120c, once the link to the access point 120a with which the user device 121 is currently associated becomes poor. The user device 121 sends a re-association request to a new access point that it located as a result of its scan. If a successful re-association response is received by the user device, the user device 121 becomes associated with the new access point. The newly associated access point then indicates the re-association through a message sent to the network 100 such that the first access point 120a may be notified of the re-association.

The access points 120a-120c connect to the remainder of the network 100 using a layer two protocol, such as Ethernet. Even if a user device momentarily loses contact with a first access point, for example 120a, the user device will establish a session with another access point, for example 120b. The star configuration of the network 100 having a single router 150 in the center allows the user device to operate with only a minor performance degradation due to the momentary loss of the connection. The higher, layer three and above, data should not experience a significant degradation in service. The user device may not even need to restart an IP session.

The user device 121 may be configured to scan for access points, 120a-120c, using one or more methods. A user device 121 may implement active scanning, where the user device 121 transmits a probe signal and waits for a probe response signal from one or more access points. The probe signals may be sent across one or a plurality of channels. An access point that receives the probe may send out a probe response signal. Thus, more than one access point may receive probe signals from a user device 121 and send out probe response signals. The user device receives the one or more probe response signals and selects one of the access points with which it wishes to associate itself. The user device 121 then sends an association message to the desired access point. The access point may then send an association response signal to the device.

Each access point may also periodically transmit a beacon signal, which may include a timestamp, power management information, and roaming information. The user device 121 may use the beacon signals to synchronize with the network. The user device 121 may also use the beacons to locate access points if roaming and association information is transmitted as part of the beacon signal. If roaming and association information forms a part of the beacon signal, the user device 121 may implement passive scanning, where the device listens for the beacon signals from access points and sends an association signal to a selected access point in response to the beacon signals. The access point receiving the association request from the user device 121 may then send an association response to associate the user device 121 with the access point. The device may be assigned an IP address by the DHCP/DNS server 148 once the device becomes associated with an access point. The DHCP/DNS server 148 manages a list of IP addresses, which it can assign to devices.

Alternatively, a device may have a static IP address. The DNS server may associate the static IP address with the device host name by using a file stored in the server, which cross references names to static IP numbers. A number of techniques are available by which a static IP may be served while roaming across a network. Examples of static IP support in roaming systems include mobile IP and other address forwarding techniques. Thus, there may be a number of different devices, some with dynamically assigned IP addresses and others with static IP addresses, all communicating with the same access point.

In a specific embodiment, the network 100 is configured as a private network with no connection to an external network 102. Each of the servers, 162, 164, 166, 142, 144, 146, and 148, is assigned a static IP address. Additionally, each user device, e.g. 121, that has access to the private network is assigned a static IP address. The user device static IP address is assigned on a geographic basis. Thus, DHCP is not used in the private network.

A user device 121 may request video content from a video server 162. The user device 121 knows the IP address of the video server because the IP address of the video server 162 is static.

The user device 121 associates with the first access point 120a which is connected by a 100Base TX link to a port on the second switch 130. A network branch 158 connects the second switch 130 to a port on the router 150. The network branch 130 is configured as a free space optical link. The first access point 120a and second switch 130 may be placed in an outdoor location, such as on the roof of a building. A first free space optical transceiver is connected to the second switch 130. The first free space optical transceiver communicates with a second free space optical transceiver placed on a rooftop of the building housing the router 150. A fiber link connects the second free space optical transceiver to the port on the router 150.

A fiber link connects another port on the router 150 to the first switch 132. Another fiber link is used to connect the first switch 132 to the video server 162. A MAC controller connected to the router 150 stores the information relating to the communication path from the user device 121 to the video server 162.

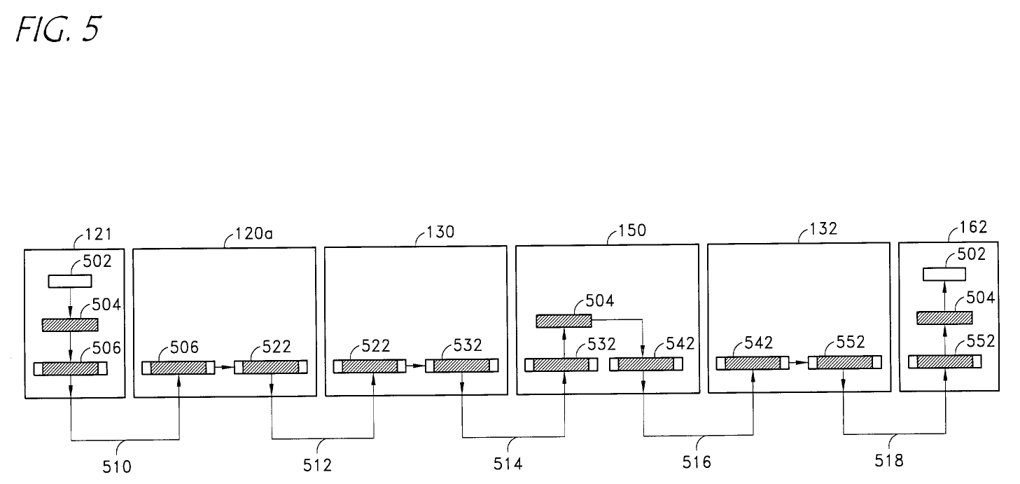

A block diagram showing the communication protocols and communication links described in the previous example is shown in FIG. 5. In order for the user device 121 to request video content from video server 162, an application within the user device 121 formats a request 502 configured according to a higher level communication protocol. The request 502 is then encoded according to a layer 3 protocol that includes the IP address of the source and destination. In this example the source is the user device 121 and the destination is the video server 162. The layer 3 encoded request 504 is then encoded in a layer 2 protocol. The layer 2 protocol includes the layer 2 address of the source and destination. Here, the source is the user device 121 and the destination is the access point 120a. The layer 3 encoded request 504 is shown as encapsulated within the layer 2, or Media Access Control (MAC) protocol. The layer 2 or MAC protocol is the 802.11a layer 2 protocol used between the access point 120a and the user device 121.

The layer 2 request 506 is then encoded within a layer 1 protocol, which allows the layer 2 request to be transmitted across the link 510 to the access point 120a. The layer 1 protocol used in the link 510 between the user device 121 and the access point 120a is the 802.11 a physical layer protocol.

The access point 120a receives the transmission over the wireless physical layer link 510 and recovers the layer 2 request 506 from the physical layer transmission. The access point 120a then strips the layer 2 protocol from the layer 3 request and re-encodes the layer 3 request 506 with the layer 2 protocol required for communication with the second switch 130. The layer 2 protocol used to communicate with the second switch 130 may be the Ethernet protocol. Thus, the layer 3 request 504 is encoded with the Ethernet address of the access point and the second switch. This layer 2 encoded request is then encoded in a layer 1 protocol for transmission across the communication link 512 from the access point 120a to the second switch 130.

The second switch 130 receives the layer 1 transmission from the communication link 512 and recovers the layer 2 request 522. The second switch 130 removes the Ethernet format and re-encodes the layer 3 request 504 using the Ethernet address of the second switch 130 as the source address and the Ethernet address of the router 150 as the destination address. This re-encoded layer 2 request 532 is then encoded with the layer 1 protocol for transmission across the communication link 514 to the router 150.

The router 150 receives the layer 1 transmission from the physical communication link 514. The router 150 recovers the layer 2 request 532 and removes the layer 2 formatting. The router 150 then examines the IP address in the layer 3 request 504 to determine to which router port the request is to be routed. In the example, the router 150 determines that the layer 3 request 504 is destined for the video server 162. The router 150 then encodes the layer 3 request 504 with layer 2 protocol and routes the request along the router port connected to the video server 162. The router 150 encodes the layer 3 request 504 with layer 2 source and destination addresses. Here the layer 2 source address is the Ethernet address of the router 150. The layer 2 destination address is the Ethernet address of the first switch 132. The layer 2 encoded request 542 is then encoded in the layer 1 protocol used in the communication link to the first switch 132.

The first switch 132 receives the layer 1 transmission from the physical communication link 516. The first switch 132 extracts the layer 2 request 542 and removes the Ethernet format. The request is then re-encoded with layer 2 protocol for transmission to the video server 162. The re-encoded layer 2 request 552 has the Ethernet address of the first switch 132 as the source address and the Ethernet address of the video server 162 as the destination address. The re-encoded layer 2 request 552 is then encoded in the layer 1 protocol used in the communication link 518 to the video server 162.

The video server 162 receives the layer 1 transmission from the physical communication link 518. The video server 162 recovers the layer 2 request 552 and determines that it is the destination. The layer 2 format is removed and the layer 3 request 504 is recovered. The video server 162 also determines that it is the IP address that is the destination of the layer 3 request 504. The video server 162 then removes the layer 3 protocol from the request to recover the higher layer encoded request.

Thus, a request from the user device 121 transitions through a number of protocols and a number of device addresses before reaching the video server 162. However, in this example the router 150 is the only device that extracts the layer 3 information to determine packet routing. Information sent by the video server 162 to the user device 121 experiences similar transitions. Thus, increasing the number of devices interposed between the user device 121 and the router 150 increases the number of times a layer 3 request is re-encoded using layer 2 protocol.

A plurality of private networks may be configured having servers with identical static IP addresses. However, as discussed above, the static IP address of a user device 121 is unique and may be assigned on a geographic basis. Thus, there is a private network for which the user device 121 considers the home private network.

The user device 121 can access servers on similarly configured private networks using the same IP addressing used for the home private network. The user device 121 is able to know the IP addresses of the various servers on any of the private networks because each of the private networks assigns its server IP addresses identically. The similarly configured private networks will know that the user device 121 is a ‘visitor’ based on its geographically assigned static IP address. Billing may be determined in part on the basis of usage of a home private network or a remote private network.

Additionally, multiple private networks may be interconnected. The external network 102 connected to a port on the router 150 by the network branch 152, may be another similarly configured private network. The network branch 152 may connect the ports of two routers for two different MANs. The network branch 152 may be an optical fiber link or may be a free space optical link. A free space optical link may be a point to point link. However, a hub may distribute the information carried on a single free space optical link to multiple optical links.

For example, the network branch 152 may be a free space optical link from a port on a router 150 within a first MAN 100 to a port on a router in a second MAN. Alternatively, the network branch 152 may be a communication link, such as a free space optical link, to a hub that simultaneously communicates to a number of routers corresponding to a number of MANs. The hub may be a terrestrial hub or may be a satellite configured as a hub.

The network branch 152 may be a free space optical link to a satellite. The satellite may be configured as a hub. The satellite may have multiple free space optical links to other routers in other MANs. Thus, a signal from a first MAN can traverse a free space optical link to a satellite. The satellite may then transmit the signal in multiple free space optical links to multiple MANs. In this manner, a private network may be expanded without the need for terrestrial optical links.

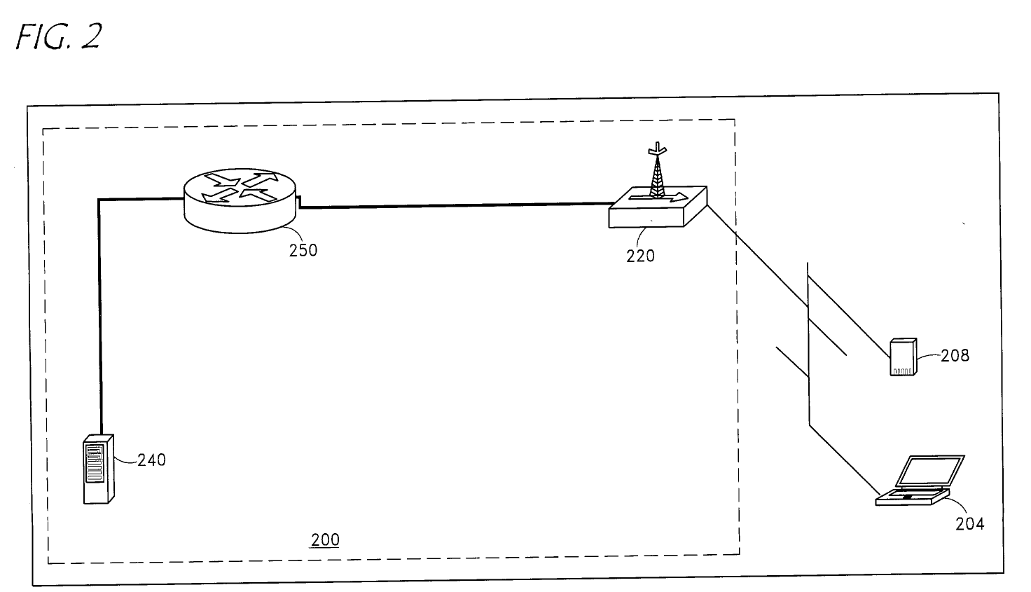

FIG. 2 is a functional block diagram of components of a MAN, such as MAN 100, providing video content to two user devices 202 and 204. The network 200 shown in FIG. 2 is a simplified version of the MAN 100 shown in FIG. 1. The network 200 is shown as comprising an access point 220, a router 250 and a video server 240. However, the network may include numerous other elements, some of which are shown in FIG. 1. A minimal number of elements are shown in FIG. 2 for ease of description.

A first user device 204, also referred to as a mobile station, portable device, or user terminal, is associated with an access point 220. In this example, the link established between the user device 204 and the access point 220 is a wireless link that may be an RF link or an optical link. Once the user device 204 associates itself with the access point 220, it is connected to the network 200. The user device may 204 be assigned a dynamic IP address or the user device 204 may have a static IP address which the network 200 uses as the user device 204 IP address for communications that use IP protocols. The user device 204 may also have addresses corresponding to other communication layers. For example, the first user device 204 may also include a MAC layer address such as an Ethernet number. In FIG. 2, the first user device is shown as a notebook computer.

A second user device 208 may also be associated with the same access point 220 that is associated with the first user device 204. The second user device 208 may also be assigned a dynamic IP address or may a have a static IP address. The second user device 208 may also include a MAC layer address such as an Ethernet number that is distinct from the MAC layer address used by the first user device 204. The second user device 208 is shown in FIG. 2 as a personal digital assistant (PDA). Thus, the second user device 208 connects with the network 200 using the same access point 220 used by the first user device 204. The first and second user devices, 204 and 208, typically have different IP addresses. More than two user devices may simultaneously associate with the access point 220 and simultaneously be connected with the network 200. Each such connected device appears as a node on the network 200. Although the first and second user devices, 204 and 208, are shown as a notebook computer and a PDA respectively, the user devices may be any type of communication device having a wireless link capable of communicating with the access point 220.

As an example, the first user device 204 may initiate communication over the network after associating with an access point 220. An application running within the device 204 may request to download a movie, multimedia, or video content from a source on the network 200. Alternatively, an application on the first user device 204 may implement communication with a server in the network 200, another user device connected to the network, or a destination external to the network 200. The application on the first user device 204 can use Transport Communication Protocol (TCP)/IP or some other higher layer communications protocol.

In order to traverse the wireless physical layer communication link between the first user device 204 and the access point 220, the data packets are encoded using the layer two protocol associated with the wireless link. The data packets encoded in the layer two protocol of the wireless link are then modulated onto a physical layer carrier, such as an RF carrier. The wireless link between the first user device 204 and the access point 220 may be a link capable of supporting 54 Mbps communication in a single channel. The link between the first user device 204 and the access point 220 may use a portion of a single channel or may use more than one channel.

The access point 220 receives the transmission from the first user device 204 and recovers the layer two data packets of the wireless link. The access point 220 determines if the user device 204 is associated with the access point 220. If the user device 204 and the access point 220 are associated, the access point 220 removes the layer two encoding and recovers the data packets.

Data packets that are sent from the access point 220 to the router 250 are encoded in a layer two protocol such as the Ethernet protocol. The layer two encoded data packets are then modulated onto a layer one, physical layer, carrier for transmission across the physical layer from the access point 220 to the router 250.

In FIG. 2, the link between the access point 220 and the router 250 is shown to be a 100 Megabit link, such as a 100Base-TX Ethernet link. The layer two encoded data packets are decoded once they reach the router 250. The router 250 examines the IP, or layer three, address contained in the data packet and determines the appropriate router port for the data packet.

In the present example, the destination of the data packets is the video server 240 connected to the router 250 using a gigabit link, such as a 1000Base-FX fiber based Ethernet link. The router 250 forwards the layer two encoded data packets over the gigabit link to the video server 240 based on the IP address. The video server 240 receives the layer two data packets and recovers the packet data. An application running on the video server 240, having the corresponding IP address, is then able to receive the packet data and interpret the contents.

In this example, the data packets corresponded to a request for video content or some similar type of multimedia file. The video server 240 provides the appropriate video content to the first user device 204. Data packets from the video server 240 are encoded with the layer three IP address and information of the destination, the first user device. The data packets are then encoded using the layer two protocol used in the network 240 between the video server 240 and the router 250. The router 250 recovers the data packets and uses the layer three IP address to determine the layer two address with which to encode the data packets. The router 250 then encodes the data packets with the layer two address of the access point 220 that is associated with the user device 204. The access point 220 receives the data packets and removes the layer two encoding. The access point 220 then re-encodes the data packets with the layer two protocol used in the wireless communication link. The layer two encoded data packets are then transmitted to the user device 204. The description of the transmission of the data packet from the source to its destination is greatly simplified in order to highlight only the layers of protocol used in traversing across the network 200.

The second user device 208 may connect with, and receive video content from, the video server 240 in a manner similar to that used by the first user device 204.

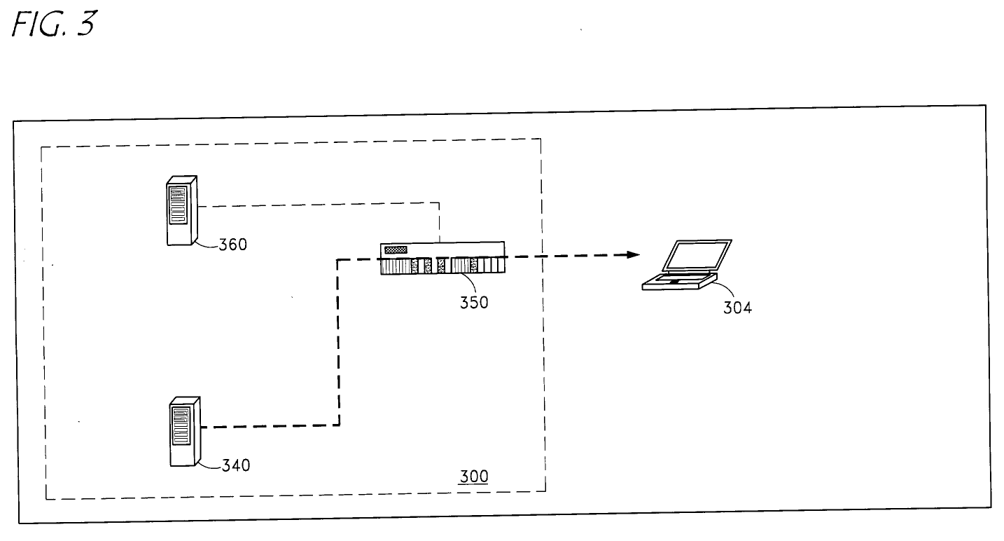

A simplified functional block diagram of a network 300 connected with a user device 304 is shown in FIG. 3. The network 300 shown in FIG. 3 is a simplified functional block diagram of the MAN shown in FIG. 1. Many elements of the MAN are not shown for ease of description. For example, the network 3 shown in FIG. 3 does not show the switches or wireless access points shown in FIG. 1, although such elements may be included in the network 300 and may be included in the communication path from the user device 304 to the video server 340.

In the functional block diagram of FIG. 3, a video server 340 provides some type of data content over the network 300 to the user device 304. For example, the video server 340 may provide video on demand to the user device 304. The video server 340 provides packet data to the router 350, which determines the router port based on at least the IP address assigned to the user device 304. A billing server 360 connected with the centralized router 350 is able to calculate billing information based on, for example the IP address of the client, the IP address of the server, the MAC address of the client, and the length or duration of the connection. In the example shown in FIG. 3, the client is the user device 304 and the server is the video server 340. The billing server 360 may determine a bill based in part on the type of service the user device 304 is requesting of the network 300.

In one embodiment, the video server 340 provides video on demand to the user device 304, but the video signals are not provided in real time. In this embodiment, the user device 340 downloads a large portion, or all, of the data file and stores it into memory within the user device 340. A large portion, or substantially all, of the video content is transmitted to and archived by the user device 304. The user device 340 may then be controlled to play the video at a later time. The user device 304 may request a specific file from the video server 340. The video server 340 then transmits to the user device 304 the video content in bursts of data packets. The use of bursty data transmission allows the video server 340 to more efficiently use the network 300. Very high data rates may be achieved during periods when the network 300 is not heavily loaded. The data rate may decrease as the network 300 becomes more heavily loaded. However, because the video server 340 is not constrained to transmit at a constant bit rate, the video signal observed by the user does not suffer.

The non-real time embodiment strains the network 300 to a lesser degree than does a real time embodiment. Corrupted data is typically only detected at the data endpoints because the network 300 typically does not perform any point-to-point data packet verification and may only provide a low degree of endpoint-to-endpoint data packet verification. Thus, detection of data errors may result in a retransmission request for the corrupted packet. Both the retransmission request and the retransmitted packets typically must traverse the entire network and must also contend with potential delays attributable to collision avoidance or collision detection. The time delays associated with error detection and retransmission in a real time video stream create strains on the network that are not present with data downloads.

In another embodiment, the video server 340 provides video content to the user device 304 in substantially real time. The real time embodiment may also be used for video on demand applications where the video content is streamed from the video server 340 to the user device 304. Alternatively, the video server 340 may push a real time video transmission to many devices or a user device 304 may initiate a broadcast from the video server 340 or some other content source to a number of devices. Unlike the non-real time embodiment discusses previously, in the real time embodiment, the video content from the video server 340 is streamed to the user device 304 at substantially the same rate at which it is required for the end application. The user device 304 only needs to buffer enough of the content to account for variations in the delivery of the data packets. The user device 304 does not need to have memory sufficient to store the entire video program. Once the user device 304 displays the streaming content, the content is discarded. Thus, a copy of the video content does not remain on the user device 304.

Real time transmission of video content produces a greater strain on the network 300 than does content downloading. Data packets from the video server 340 may be prioritized and may need to be sent at precise intervals. A steady data transmission throughput across the network 300 may need to be maintained. The video server 340 and user device 304 may coordinate control of the data packet transmission by implementing a data protocol that allows for real time transmission of video content over a network 300.

For example, the user device 340 may set up a single one way connection with the video server 340 and the video server 340 may provide all of the content over the single channel in a controlled manner with no feedback from the user device 304. This implementation may not ensure timely delivery of packets nor guarantee any quality of service for content transmission.

Alternatively, the user device 304 may set up three network connections with the video server 340 on three different ports in order to receive real time video content. One duplex channel may be used for control and negotiation. A unidirectional channel is used by the video server 340 to send the video content over the network 300 to the user device 304. A second duplex channel is used to provide synchronization information to the user device 304 and packet loss information to the video server 340. The use of multiple channels, some for control and others for video content, allows the user device 304 and video server 340 to have greater control over the delivery of the video transmission. For example, the user device 304 may control the video server 340 to pause, rewind, or fast-forward the video transmission.

The user device 304 may set up from, and tear down to, an initialization state. The device may advance to a ready state following set up. From the ready state, the device may advance to a playing state. The device may also move from the playing state to a ready state and tear down back to the initialization state.

Examples of protocols that may be used to direct real time video content across the network 300 include Real Time Transport Protocol (RTP) and Real Time Streaming Protocol (RTSP). It may be understood that the network is not limited to using either of these protocols for video streaming and that the network may support a variety of video protocols.

The billing server 360 may negotiate and track billing with the user device 304 for a series of transactions across the network 300 or may negotiate and track billing of the user device 304 based on duration of the network connection. The billing server 360 may track and calculate a billed value based on a variety of factors. For example, the user device 304 may negotiate with the billing server 360 a value associated with a non-real time, or archived, video download. The value associated with an archived video download may be pre-established. The contract negotiation between the billing server 360 and the user device 304 may entail notifying the billing server 360 of the identity of the user device 304, specific content downloaded, and start and stop times of the download. Because archived video content strains the network 300 to a lesser extent than does real time streaming video, the associated cost of archived video content may be lower than the cost of real time streaming video. Alternatively, the convenience of archived video content may be a feature for which consumers may be willing to pay a premium. Thus, archived video content may cost the user more than does real time streaming video, while straining the network 300 to a lesser extent than streaming video. Additionally, the billing server 360 may determine a cost based in part on the type of data sent to the user device 304. For example, the billing server may distinguish content delivered using TCP from WAP delivered content.

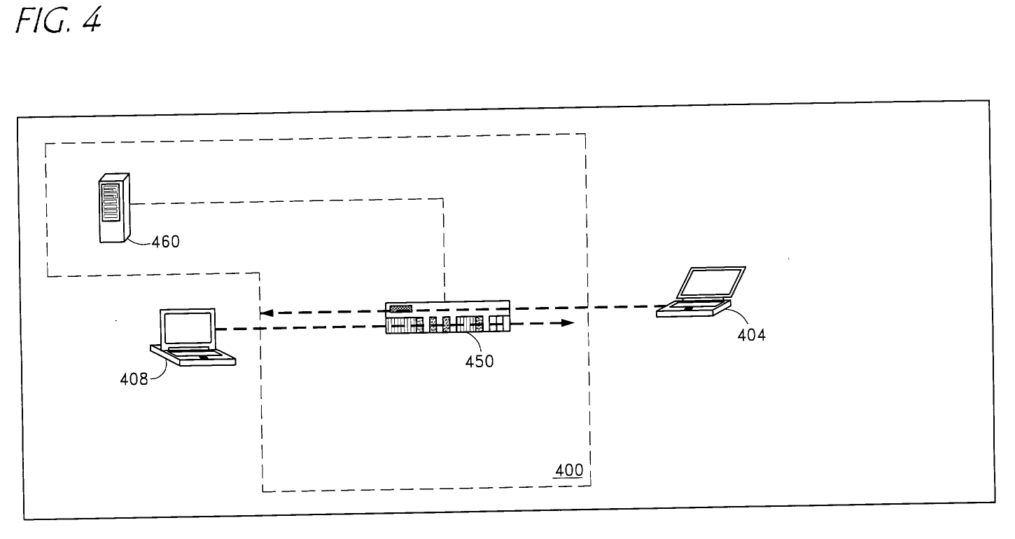

FIG. 4 represents a simplified functional block diagram of another application operating within a network 400. Once again, the network 400 shown in FIG. 4 is a simplified functional block diagram of the MAN shown in FIG. 1. The network elements such as the various servers, switches, and wireless access points are not shown. The network connections to the user devices, 404 and 408, are not shown in the figure, but may be accomplished using any of the connections described in FIG. 1. For example, the user devices, 404 and 408, may each utilize a wired or wireless connection to the network 400.

FIG. 4 shows a first user device 404 operating in a video conference with a second user device using the network 400 to carry the communications to and from each of the devices. It may be understood that both user devices, 404 and 408, are capable of transmitting video signals across the network 400 as well as receiving video signals across the network 400. Here, as in previous examples, the term video signals is used to denote visual content, audio content, or a combination of both.

In a typical video conference application, the first user device 404 generates a local video signal using a video camera and microphone (not shown) and transmits these signals across the network 400 to the second user device 408. The first user device receives video signals across the network 400 and is capable of transforming them into visual content that is displayed on the video device 404 or broadcast using a speaker (not shown) on the user device 404. The second user device 408 performs functions complementary to those performed by the first user device 404. All of the functions performed by the first and second user devices, 404 and 408, may be integrated into a single unit or may be performed by a plurality of elements.

The signals from each of the first and second user devices, 404 and 408, are provided to the single network router 450 that is used to determine the destinations of the respective video signals. Unlike the previously described video on demand application, video conferencing transmits substantially the same amount of information in both directions.

A billing server 460 may track several factors in the video conference connection in order to determine an associated cost. For example, the billing server 460 may track the IP addresses of the initiating and remote clients, the MAC addresses of the initiating and remote clients, and the duration of the connection. Video conferencing places a greater load on the network 400 because there is two way flow of point-to-point information that may be delay sensitive.

The network 400 does not ensure the timing or quality of service for video conferencing by analyzing the data packets sent across the network 400. Thus, the user devices, 404 and 408, typically implement some type of video conferencing protocol to ensure low latency and quality of service. For example, the user devices may implement a protocol that operates in accordance with a standard promulgated by the International Telecommunications Union (ITU) such as the H.323 standard. The H.323 standard incorporates a number of other standards for performing specific tasks within a video conferencing connection.

For example, H.323 supports transmission of video content using the Real Transport Protocol (RTP). Additionally, ITU standard H.263 specifies a payload format for encapsulating a bitstream in RTP. Three formats may be defined for a payload header to allow fragmentation of the video content along different frame boundaries.

The user devices, 404 and 408, may implement an application to limit the amount of bandwidth required by the data packets sent over the network 400 in order to improve the quality of service. For example, the user devices, 404 and 408, may capture and send only the images of the faces of the video conference participants in order to minimize the amount of data that needs to be sent over the network 400.

A network configuration has been disclosed that provides high speed wireless connectivity to user devices. A metropolitan area network may comprise one or a plurality of local area networks connected to a single router in the center of a star network configuration. The wireless link from mobile terminals to the network operates using layer two protocol carried on a defined wireless physical layer. The data on the network received by wireless access points is directed to the router using a layer two protocol, which may be Ethernet. The single router at the center of the network routes data packets using layer three information, which may include Internet Protocol (IP) addresses. Network branches emanating from ports on the router provide communication links switches. Links connect the switches to servers and access points. A network branch may be used to connect a router port to a switch in order to increase the number of communication links in the network without unduly increasing the umber of ports on the router. The switches direct data to and from the links and network branches using layer two information, such as MAC addresses.

While the above detailed description has shown, described, and pointed out novel features of the invention as applied to various embodiments, various omissions, substitutions, and changes in the form and details of the device or process illustrated may be made by those skilled in the art without departing from the scope of the invention. The scope of the invention is indicated by the appended claims rather than by the foregoing description. All changes which come within the meaning and range of equivalency of the claims are to be embraced within their scope.

Electrical and/or signal connections, couplings, and connections have been described with respect to various devices or elements. The connections and couplings may be direct or indirect. A connection between a first and second device may be a direct connection or may be an indirect connection. An indirect connection may include interposed elements that may process the signals from the first device to the second device.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, elements, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the invention.

The various illustrative logical blocks, modules, and elements described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC or as discrete components.

The above description of the disclosed embodiments is provided to enable any person skilled in the art to make or use the invention. Various modifications to these embodiments will be readily apparent to those skilled in the art, and the generic principles defined herein may be applied to other embodiments without departing from the scope of the invention. Thus, the invention is not intended to be limited to the embodiments shown herein but is to be accorded the widest scope consistent with the principles and novel features disclosed herein.

What is claimed is:

1. A communication system adapted to provide wireless communications, the communication system comprising:
an access point comprising a wireless transceiver configured to receive data from a communications device over a wireless link, the data including a third communication protocol address and encoded according to a first communication protocol, and the access point further configured to encode the data according to a second communication protocol for transmission across a communication path, the data directed from the access point across the communication path using the second communication protocol;
a router having a plurality of ports, a first port on the router connected to the access point, the router configured to receive the data from the communication path, remove the second communication protocol and determine a second port on the router to which the data is to be routed based at least in part on the third communication protocol address, the router further configured to encode the data using the second communication protocol for transmission from the second port; and
a device connected to the second port on the router, the data directed from the router to the device using the second communication protocol, the device configured to remove the second communication protocol from the data.

2. The communication system of claim 1, further comprising a switch having a first switch port connected to the access point, a second switch port connected to a second access point, and a third switch port connected to the first port on the router, the switch configured to receive the data encoded according to the second communication protocol from the access point and direct the data to the first port on the router based at least in part on a field of the second communication protocol.

3. The communication system of claim 2, wherein the connection from the third switch port to the first port on the router comprises an optical link.

4. The communication system of claim 1, wherein the second communication protocol is an Ethernet protocol.

5. The communication system of claim 1, wherein the data comprises packet data.

6. The communication system of claim 1, wherein the router determines the second port on the router to which the data is to be routed based at least in part on an Internet Protocol (IP) address.

7. The communication system of claim 1, wherein the device is a second access point configured to remove the second communication protocol from the data, encode the data using the first communication protocol, and transmit the data over a second wireless link.

8. The communication system of claim 7, further comprising:
a first user device wirelessly coupled to the access point; and
a second user device wirelessly coupled to the second access point and configured to video conference with the first user device.

9. The communication system of claim 1, further comprising a billing server coupled to the router to determine a cost of a use of the communication system.

10. The communication system of claim 9, wherein the billing server determines a cost based at least in part on an IP address of the communications device and a duration of connection to the communication system.

11. The communication system of claim 1, further comprising:
a first sub-network connected to the first port on the router comprising a first access point; and
a second sub-network connected to the second port on the router comprising a second access point, the second access point having a coverage area mutually exclusive of a coverage area of the first access point.

12. A method of network communication in a network having a plurality of access points configured to simultaneously provide network access to a plurality of user devices, the method comprising:
communicating information from a first wireless access point to a router over a physical channel, the physical channel carrying information encoded according to a first communication protocol, the first communication protocol encoding information encoded using a second communication protocol, the information encoded using the second communication protocol including at least a second communication protocol address of the router and information encoded using a third communication protocol;
determining a routing path using at least a portion of the information encoded using the third communication protocol, the act of determining the routing path performed by the router; and
routing, using the router, the information encoded using the third communication protocol to a destination, the router encoding the information using the second communication protocol for transmission to the destination.

13. The method of claim 12 further comprising determining, based at least in part on a field of the third communication protocol, a cost of communication in the network;

14. A communication system adapted to provide wireless communications, the communication system comprising:
an access point configured to receive a data packet including an Internet Protocol (IP) address from a user device over a wireless link, the data packet being encoded by a Media Access Control (MAC) protocol, the MAC encoded packet is encoded by a first physical layer protocol for transmission across the wireless link, the access point configured to remove the first physical layer and MAC protocols from the data packet and to encode the data packet with an Ethernet protocol and a second physical layer protocol;
a router with a plurality of ports having a first router port connected to the access point, the router configured to receive from the access point the data packet encoded with the Ethernet protocol and the second physical layer protocol, the router determining, at least in part on the IP address, a second router port to which the data packet is routed, the router configured to encode the data packet with the Ethernet protocol and the second physical layer protocol prior to transmitting from the second router port; and
a destination identified with the IP address and connected to the second router port, the destination configured to recover the data packet by removing the second physical layer protocol and the Ethernet protocol.

15. The communication system of claim 14, wherein the destination is a server comprising a storage device to store content which is accessible by a user device in communication with the access point.

16. The communication system of claim 15, wherein the content is video content.

17. The communication system of claim 15, wherein the server transmits the content to the user device using bursty transmissions.

18. The communications system of claim 15, wherein the server transmits a video signal to the user device at substantially a real time rate.

19. The communications system of claim 15, further comprising a control link between the server and the user device, wherein the user device may transmit control signals to the server to control a flow of the video signal to the user device.

20. The communication system of claim 15, wherein the server is configured to transmit data to the user device using Real Time Streaming Protocol (RTSP).

21. A communication system adapted to provide wireless communications, the communication system comprising:
a first access point configured to receive a data packet including an Internet Protocol (IP) address from a first user device over a first wireless link, the access point encoding the data packet using a layer two protocol;
a router having a first port connected to the first access point, the router configured receive the data packet encoded using the layer two protocol and to determine a second router port to which the data packet is routed based at least in part on the IP address, and the router encoding the data packet using the layer two protocol;
a second access point connected to the second port on the router, the second access point configured to receive the data packet from the router, the second access point configured to communicate the data packet over a second wireless link to a second user device identified with the IP address.

22. The communication system of claim 21, wherein the first access point is configured to support a plurality of channels.

23. The communication system of claim 22, wherein the first access point communicates with a user device simultaneously over at least two of the plurality of channels.

24. The communication system of claim 21, wherein the access point is configured to communicate at a data rate of 54 Mbps.

25. The communication system of claim 21, wherein the wireless link comprises an orthogonal frequency division multiplexed radio frequency link.

26. A communication network comprising:
a first wireless access point configured to receive a data packet including layer three information from a source, the first wireless access point also configured to encode the data packet with a layer two communication protocol and transmit the encoded data packet across a communication link;
a router having a plurality of ports, a first of the plurality of ports connected to the first wireless access point, the router configured to receive the layer two encoded data packet from the first wireless access point and determine a second of the plurality of ports to which the data packet is routed based at least in part on the layer three information, the router also configured to encode the data packet with the layer two protocol prior to transmitting from the second of the plurality of ports;
a destination corresponding to the layer three information connected to the second of the plurality of ports, the destination configured to receive the data packet and remove the layer two protocol; and
a billing server connected to the router, the billing server configured to determine a billing cost based at least in part on the layer three information.

27. The communication network of claim 26, wherein the layer three information is an Internet Protocol (IP) address and the destination is a content server having a static IP address corresponding to the IP address.

28. The communication network of claim 26, wherein the billing server is further configured to determine a billing cost based in part on a duration for which the source is in communication with the destination.

29. A method of network communication, the method comprising:
receiving at an access point, over a wireless communication link, a data packet encoded in a physical layer protocol;
removing a physical layer protocol to recover a first layer two data packet;
removing a first layer two protocol to recover a layer three data packet;
encoding the layer three data packet using a second layer two protocol;
forwarding, using second layer two information, the layer three data packet from the access point to a first port on a router;
receiving at the router the layer three data packet encoded using the second layer two protocol;
removing the second layer two protocol to recover the layer three data packet;
determining, using layer three information, a second port on the router to which the layer three data packet is to be directed;
determining, based at least in part on the layer three information, a cost of communication in the network;
encoding the layer three data packet using the second layer two protocol; and
forwarding, using layer two information, the layer three data packet to a destination connected to a second port on the router.

30. The method of claim 29, wherein the act of forwarding the layer three data packet from the access point to a first port on a router comprises:
generating a layer two packet having a layer two address of a switch as a layer two destination;
transmitting, from the access point to the switch, the layer two packet having the layer two address of the switch as the layer two destination;
receiving, at a first port on the switch, the layer two packet having the layer two address of the switch as the layer two destination;
generating a layer two packet having a layer two address of the router as the layer two destination;
transmitting, from a second port on the switch to the router, the layer two packet having the layer two address of the router as the layer two destination.
